(19) United States
(12) Patent Application Publication
(10) Pub. No.: US 2015/0296507 A1
(43) Pub. Date: Oct. 15, 2015

(54) MULTIPATH COMMUNICATION

(71) Applicant: NOKIA CORPORATION, Espoo (FI)

(72) Inventors: Jarkko Lauri Sakari Kneckt, Espoo (FI); Olli Alanen, Vantaa (FI)

(21) Appl. No.: 14/442,767

(22) PCT Filed: Dec. 7, 2012
(86) PCT No.: PCT/FI2012/051214

§ 371 Date: May 14, 2015

(51) Int. Cl. H04W 72/04

(52) U.S. Cl. CPC H04W 72/0446; H04W 84/12

(57) ABSTRACT

There is provided a method, comprising: transmitting, by a user equipment (100), at least one uplink data frame (400) to a first access point (102) of a wireless local area network, wherein the first uplink data frame of the transmitted at least one uplink data frame initiates a transmission opportunity (416); and transmitting at least one up-link data frame (404) to a second access point (104) of a wireless local area network within the same transmission opportunity (416).

### FIELD

The invention relates generally to wireless local area communication networks. More particularly, the invention relates to multipath communication.

### BACKGROUND

In parallel with cellular data networks, such as the Long Term Evolution (LTE) or the LTE-Advanced (LTE-A) of the 3^{rd} Generation Partnership Project (3GPP), Wi-Fi is being deployed continuously. Wi-Fi devices may use a wireless local area network (WLAN), for example. It may be that the devices may use either the cellular network or Wi-Fi network at any given point in time. It may also be that a single device is connected to several access points at the same time. In this way multiple paths may be generated for the communication. For example, when the bottleneck of the network is in the wired lines (e.g. ADSL modems), having multiple paths in the network side may increase the overall capacity.

### BRIEF DESCRIPTION OF THE INVENTION

According to an aspect of the invention, there are provided methods as specified in claims 1 and 16.

According to an aspect of the invention, there are provided apparatuses as specified in claims 18, 33, 35, and 50.

According to an aspect of the invention, there is provided a computer program product as specified in claim 52.

According to an aspect of the invention, there is provided a computer-readable distribution medium carrying the above-mentioned computer program product.

According to an aspect of the invention, there is provided an apparatus comprising processing means configured to cause the apparatus to perform any of the embodiments as described in the appended claims.

According to an aspect of the invention, there is provided an apparatus comprising a processing system configured to cause the apparatus to perform any of the embodiments as described in the appended claims.

According to an aspect of the invention, there is provided an apparatus comprising means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a wireless local area network (WLAN) according to an embodiment;

FIGS. 2, 3, 5, 6, 8 and 10 show methods according to some embodiments;

FIG. 4 shows a signal flow diagram according to an embodiment;

FIG. 7 illustrates an uplink burst element according to an embodiment;

FIG. 9 depicts uplink data frame transmissions to a plurality of different access points according to an embodiment; and

FIGS. 11 and 12 illustrate apparatus according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

The number of IEEE 802.11-enabled mobile devices is ever increasing. The IEEE 802.11 is a set of standards for implementing wireless local area network (WLAN), also known as the Wi-Fi. Such an IEEE 802.11-enabled station (STA) may apply multipath methods. Such multipath methods and/or transmission control protocols (TCP) are currently under development. The multipath methods may be used in creating flexibility to the handovers and especially in enabling traffic offloading from wide area (WA) network to local area (LA) network. The use of multipath methods may require support from both the source and the destination devices. The WLAN-capable STA device may need to use a legacy TCP with the receivers that do not support multipath methods. The legacy TCP may have a single address for all data transmissions and all the packets are addressed to a single destination address.

During the multipath TCP and multipath real-time transport protocol (RTP) protocols development, the devices may make similar solutions that try to imitate the use of multipath protocols. For instance, some applications open multiple TCP connections simultaneously to speed up the data transmission and to contact multiple servers. When device cannot use multipath protocols but has many associations, the device may divide the opened TCP connections to different associations to balance the amount of traffic delivery among different access points and paths. Similarly as in multipath protocols use, the balancing of the traffic may increase the overall capacity and make the data transmission more reliable.

However, it may be that the transmission throughputs of the local area networks are higher than the throughput of the backbone network that connects the local area network to Internet. Therefore, it may be assumed that the bottleneck in wired lines (e.g. ADSL model). Further, the link setup times will most likely be decreasing in near future. Consequently, the link setup to the local area network consumes less energy, it is faster and simultaneous operation in other network is easier to implement. As the backbone connection to Internet is assumed to limit the throughput of the WLAN STA, the air interface throughput enhancements do not typically affect to the achievable throughput, rather they merely improve the transmitter and receiver power efficiency. Thus, alternative solutions may be needed.

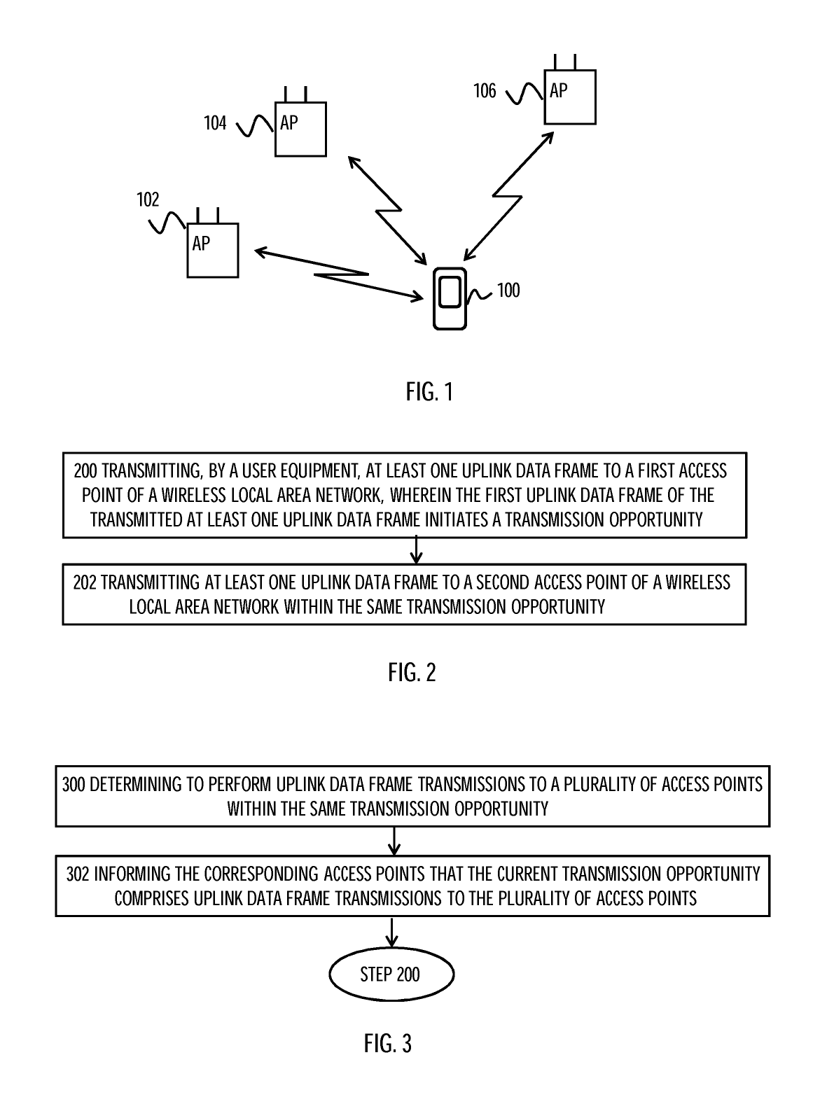

As shown in FIG. 1, when the WLAN STA 100 associates to multiple access points (APs) 102 to 106 of the WLAN network, the STA performance and operation may be optimized. However, typically a WLAN handheld device has a single WLAN radio. Multiple WLAN radios in a device would create more cost to the device and increase the size of the device. Therefore, it may be that many APs 102 to 106 have the same primary channel. It may also be so that an area has so many APs in proximity that several of them have the same primary channel. It should also be noted that such multipath TCP may be a layer 3 protocol, which may not consider multiple AP usage of the WLAN.

The STA 100 may comprise a mobile phone, a palm computer, a wrist computer, a laptop, a personal computer, or any device capable to access the WLAN radio air interface. The access point 102 to 106 may be a WLAN base station, for example.

When the STA 100 transmits data to multiple APs 102 to 106, then according to currently available methods, each uplink (UL) and downlink (DL) transmission have their own transmission/transmit opportunity (TXOP). As known, between the multiple TXOPs there is a distributed inter-frame space (DIFS) and back-off calculation (random access time), according to channel access rules and parameters, before the data is transmitted (i.e. before the TXOP is started). This may cause delays, e.g., to the UL transmissions over the multiple paths.

In order to optimize the STA 100 operation and efficiency, it is proposed as shown in FIG. 2 to transmit, by the STA 100 (e.g. the UE 100) in step 200, at least one UL data frame to a first AP 102 of the wireless local area network (WLAN), wherein the first UL data frame of the transmitted at least one UL data frame initiates a TXOP. Instead of terminating the on-going TXOP, the UE 100 continues in step 202 by transmitting at least one UL data frame to a second AP 104 of the WLAN within the same TXOP. Thus, this single TXOP may be called a multipath TXOP. In an embodiment, the second AP 104 may apply the same primary channel as the AP 102. Therefore, there is a transmission of UL data frames to a plurality of APs 102, 104 within/during one TXOP time period. In this way, the proposed solution to optimize the network solution enables the UE 100 to transmit its UL traffic to multiple APs 102, 104 within one multipath TXOP, that is, within one “UL burst”.

The proposal of FIG. 2 may enable the terminal 100 to trigger service periods with APs 102 to 106 in shorter time and to transmit UL traffic as a large traffic burst to all APs 102 to 106. As known, the service period is a time when the corresponding AP 102, 104, 106 knows that the terminal 100 is available to receive AP's transmissions. These capabilities shorten the data transmission time, increase throughput and reduce the operation time in active mode. Further, the total operation time with multiple APs 102 to 106 on the channel is minimized.

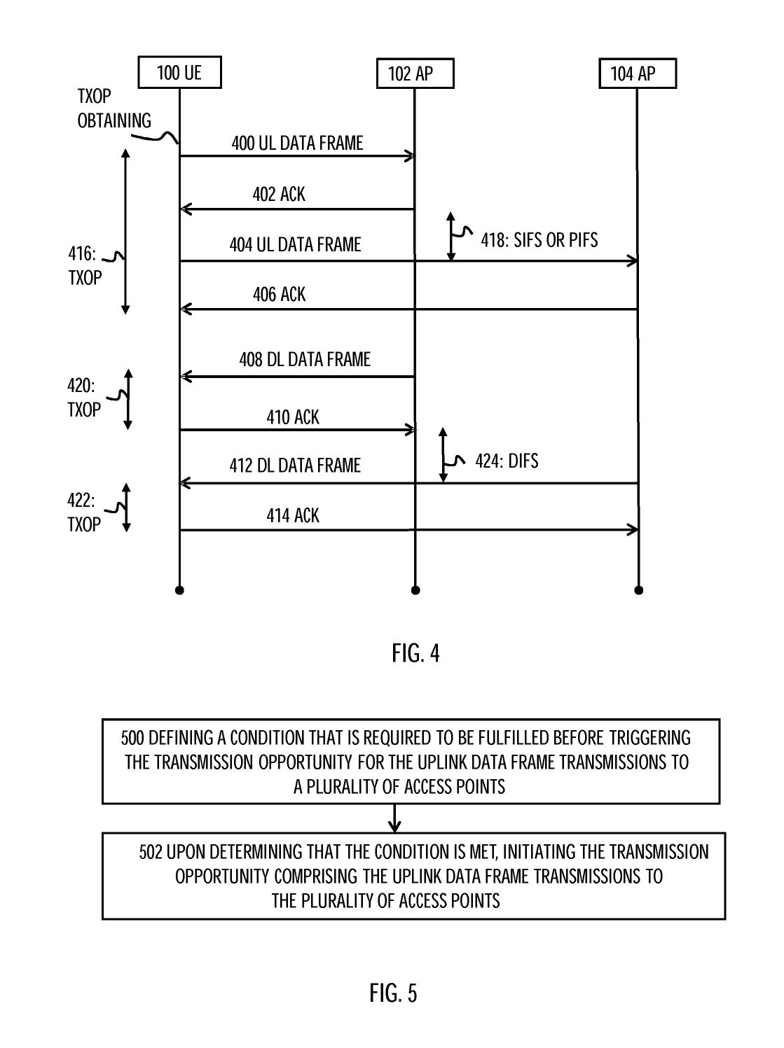

FIG. 4 illustrates the scenario as a flow diagram. First the UE 100 transmits the first UL data frame 400 to the AP 102. The transmitted UL data frame may be a trigger frame, for example. The trigger frame is related to power saving. The trigger frame may indicate that the STA 100 is awake and may receive data. In this way, the TXOP may be initiated when the frame 400 is transmitted to one of the plurality of APs 102, 104. The TXOP is considered to be the time during which a transmitter transmits data and receives ACKs, i.e. time reserved for data transmission. In an embodiment, the STA 100 receives an acknowledgement (ACK) from a corresponding AP 102 or 104 with respect to the transmitted at least one UL data frame. The STA 100 may receive an ACK for each of the transmitted UL data frames. For example, the STA 100 receives the ACK in step 402 from the AP 102 to which the UL data frame 400 was sent. If the sending station 100 does not receive an ACK frame within a predetermined period of time, the sending station 100 may resend the frame.

Next the STA 100 may transmit another UL data frame 404 to the AP 104, which is different than the AP 100, during the same (multipath) TXOP. Again, the UL data frame 404 may be a trigger frame, for example. Further, the STA 100 may receive an ACK 406 from the AP 104 to which the UL data frame 404 is sent. AP 106 is not shown in FIG. 4 the sake of simplicity of the figure. As shown in FIG. 4, the transmissions and ACK-receptions to/from a plurality of different APs are all performed within one TXOP 416. Each transmitted PPDU (i.e. UL data frame) during the UL burst may be addressed to a different AP 102, 104, 106. It should be noted that all the traffic may be transmitted in a burst regardless of the access category of the MAC service data unit.

As said, the UL data frame 400, 404 may be a trigger frame, a null frame, or a PLOP protocol data unit (PPDU), where the PLOP stands for a physical layer convergence protocol. In an embodiment, the UL data frame also includes information regarding the receiving AP 102, 104, or 106 in a header of each of the UL data frame 400, 404. The header may be a PLOP header, as in IEEE 802.11ac. Such PLOP header provides guidance to the transmitter and to the receiver of the transmission. For instance, the use of PLOP header enables the receivers to estimate are they the receivers of the traffic or not. Further, the 802.11ac transmission mechanism enables devices to use power save during the network allocation vector (NAV) duration of the transmission, if they detect that the transmission is addressed to other device. When an UL transmission is addressed to multiple APs, the PLOP header may indicate that the frame should be received by many APs. Thus, each UL data frame may be addressed to one AP among the plurality of APs 102 to 106, or to at least two APs among the plurality of APs 102 to 106.

After the initial TXOP 416 obtaining, the following PPDU 400, 404 (i.e. UL data frame) transmissions may be done so that the time period 418 after the previous ACK 402 or PPDU 400, 404 transmission equals to a short inter-frame space (SIFS) or a point coordination function (PCF) IFS (PIFS). The PIFS is equal to SIFS plus one slot time. The PIFS is present, if the transmission bandwidth is increased during the UL burst transmission. For instance different APs 102 to 106 may use different channel bandwidth values. The device may sense that the larger bandwidth is available and transmit the frames with larger bandwidth that may result to higher transmission rates and shorter transmission durations. Otherwise, only the SIFS is waited in the period 418. In this way, we can get rid of the distributed IFS (DIFS) waiting and back-off calculation for the UL direction. The DIFS is equal to the SIFS plus two slot times. That is, DIFS>PIFS>SIFS. These time periods are predefined by the physical layer in the IEEE 802.11. As a result, in an embodiment, the UE 100 waits a time period, which is shorter than the DIFS, between the data frame transmissions to different APs 102, 104 within the same TXOP.

It should be noted that even though FIG. 4 depicts only one UL data frame 400, 404 transmission to each AP 102, 104, there may be many UL data frames transmitted to the same AP 102, 104. For example, UL data frame transmission from the STA 100 to the APs 102, 104 may follow the trigger frame transmissions 400, 404, although not shown in FIG. 4. In an embodiment, the UL data is transmitted first and then the APs 102, 104 transmit their buffered data to the UE 100 (i.e. UL data is transmitted first before receiving any DL data frames from the APs 102, 104). This may be advantageous because if the UL data transmission would be left to a later phase, it may happen that the AP 102, 104 transmits all its buffered DL traffic and the last frame from the AP 102, 104 terminates the current service period. Then the remaining UL data transmissions from the STA 100 to the AP 102, 104 might open a new service period and cause transmission of an additional service period termination frame (null frame) to the STA 100. This embodiment may provide benefits from viewpoint of traffic delays and terminal power save.

After the UL data is transmitted to the APs 102 to 104, the AP 102 may then transmit DL data frames 408 (one or more) to the STA 100 and receive an ACK 410 from the STA 100. Similarly, the AP 104 may transmit DL data frames 412 (one or more) to the STA 100 and receive an ACK 414 from the STA 100. After the AP 102, 104 has transmitted all its buffered data to the STA 100, the last frame from the AP 102, 104 may then carry an indication of the end of service period (EOSP=1), which terminates the current service period. That is, it indicates to the terminal 100 that the STA 100 will not receive more data from the corresponding AP 102, 104. The last frame carrying the EOSP=1 may be a null frame, for example.

It should be noted that the in the DL direction, there are separate TXOPs 420, 422 for each AP 102, 104. Each DL TXOP 420, 422 is separate and, as said, the last DL data frame from the AP associated with the TXOP may comprise the “EOSP=1” indication. After that, the next DL TXOP may be started by a different AP. As such, the time period 424 waited between different TXOPs 420, 422 (i.e. between DL data transmission from different APs 102, 104) may equal to the DIFS, which is longer than the SIFS or the PIFS. Consequently, the STA 100 may receive at least one DL data frame from each of the APs 102 to 104, wherein the DL data frame transmissions from different APs 102 to 104 take place in different TXOPs 420, 422.

In an embodiment, as shown in FIG. 3, the STA 100 may first in step 300 determine to perform UL data frame transmission to a plurality of APs 102 to 106 within the same (multipath) TXOP. Such determination may be due to various triggers, including special enhanced distributed channel access (EDCA) parameters, as will be described later. In step 302, the STA 100 may inform the corresponding APs 102 to 106 that the current TXOP 416 comprises UL data frame transmissions to the plurality of APs 102 to 106. The informing may take place as a dedicated signaling, included in the PPDU transmissions of the UL burst, etc.

In an embodiment, as shown in FIG. 5, the STA 100 may in step 500 define a condition that is required to be fulfilled before triggering the TXOP 416 for the UL data frame transmissions to a plurality of APs 102 to 106 (i.e. before triggering the UL burst). As said, the initiation of the TXOP 416 may be performed by the STA 100 transmitting the first UL data frame 400. Thus, before the STA 100 transmits any UL data frames in the UL burst (i.e. in a single TXOP 416 covering transmission of several UL data frames to different APs 102 to 106), the defined condition needs to be met. Thereafter, in step 502, upon determining that the condition is met, the STA 100 may initiate the TXOP 416 comprising the UL data frame transmissions to the plurality of APs 102 to 106.

In an embodiment, the condition is defined by the EDCA parameters and the condition requires at least that the traffic load on the applied (primary) channel is below a predetermined threshold. In other words, the EDCA parameters may be used in obtaining the TXOP 416. With EDCA, high-priority traffic has a higher chance of being sent than low-priority traffic: a station with high priority traffic waits a little less before it sends its packet, on average, than a station with low priority traffic. This is accomplished by using a shorter contention window (CW) and shorter arbitration inter-frame space (AIFS) for higher priority packets. The levels of priority in EDCA are called access categories (ACs). Each AP 102, 102, 106 may set own EDCA parameters into use. The EDCA parameters may include, as known by a skilled person, a CWmin for defining the minimum duration of the CW, a CWMax for defining the maximum duration of the CW, the AIFSN and a TXOPLimit for defining the maximum duration for the TXOP with respect to the AP associated with these EDCA parameters. In an embodiment, the EDCA parameters may be with respect to certain access category, such as for the AC BE (best effort).

The current traffic transmission limitation mechanisms enable the APs 102, 104, 106 to control and coordinate the EDCA parameters use of the associated STA 100. However, the UL burst transmits UL traffic to multiple APs 102, 104, 106 and the EDCA parameters used in the transmission cannot be controlled by a single AP. Further, the APs 102 to 106 may have “equal” control and each AP 102, 104, 106 may decide only on its behalf. As indicated, the STA 100 may use only a single set of the EDCA parameters at once. Thus, the STA 100 may not use AP-specific parameters for the UL burst 416. For this reason, in an embodiment, the STA 100 may need to define the EDCA parameters by itself. In order to accomplish this, the STA 100 may have preconfigured EDCA parameters stored for triggering the UL burst 416, for example. In another embodiment, in a case where the APs 102 to 106 apply the same EDCA parameters, the STA 100 may apply those EDCA parameters which are the same for all the APs 102 to 106. In one embodiment, the EDCA parameters may be modified to allow high priority traffic to transmit first, before the UL burst 416. For example, relatively poor EDCA parameters to obtain the TXOP 416 for the UL burst ensure that the UL burst is initiated only if the network has only little other transmissions

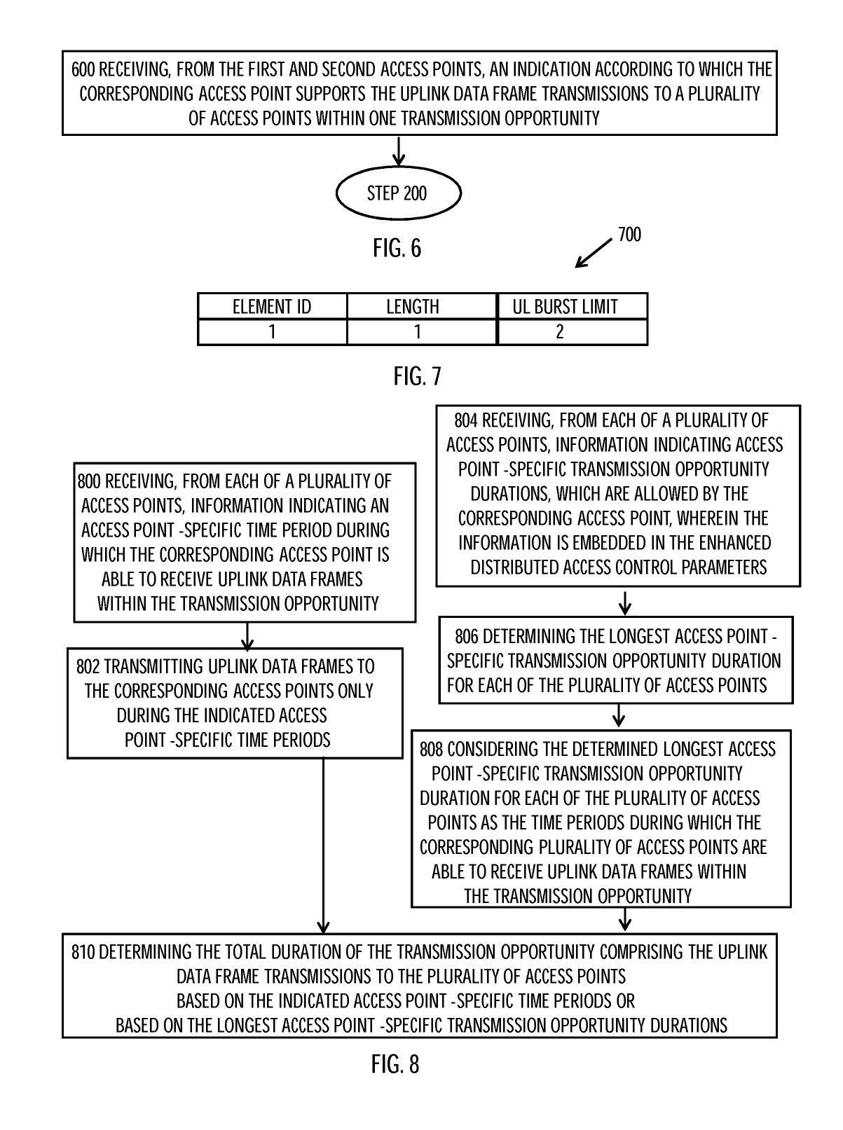

In an embodiment, as shown in FIG. 6, the STA 100 may in step 600 receive, from each of the APs 102, 104, 106, an indication according to which the corresponding AP 102, 104 supports the UL data frame transmissions to a plurality of APs 102 to 106 within one TXOP. That is, the APs 102 to 106 may separately indicate whether they support the UL burst/bursting or not. In an embodiment, the indication, a so-called UL burst element, may be transmitted to the STA 100 in at least one of the following: a beacon, a probe response message, an association response message, a dedicated message. The beacon is a frame sent periodically from an AP 102 to 106 to announce its presence. The probe response frame, on the other hand, is sent from an AP 102 to 106 on request and it contains capability information, supported data rates, etc. The association response frame is sent from an AP 102 to 106 to a station 100 and it contains the acceptance or rejection to an association request.

The use of the UL burst may thus be controlled by the APs. In an embodiment, the AP 102, 104, or 106 enable the UL bursts (i.e. support the UL burst), when the traffic load in the applied channel is small. In other words, the multipath delivery enhancement may be enabled when the network is not congested. If the access delays in the corresponding AP or in the associated terminals increase over predefined threshold, the UL bursts may not be allowed. In an embodiment, a central entity, such as an access controller, may coordinate the AP-specific allowance of the UL bursts. When supported and enabled by the AP, a reception of a burst of UL traffic triggers the APs 102 to 106 to transmit their DL traffic to the STA 100. This operation simplifies the AP operation, because the APs 102, 104, 106 may immediately terminate the service period and the terminal 100 knows when the UL traffic is transmitted.

An example UL burst element 700 transmitted from the APs 102, 104, 106 to the STA 100 is illustrated in FIG. 7. In an embodiment, the UL burst Limit-field may be specified as an unsigned integer, with the least significant octet transmitted first, in units of 32 μs. In another embodiment, only a single bit is set to 1 to indicate that UL burst transmissions from the STA 100 are allowed. Thus, no UL burst element 700 needs to be transmitted to the STA 100. Therefore, this latter embodiment may shorten the signaling related to the UL burst element.

The UL burst limit-field of the UL burst element 700 defines the time during an UL burst that the device 100 may transmit the UL data frames and receive ACKs to/from the AP associated with the received UL burst element 700. In this manner, in an embodiment, as shown in step 800 of FIG. 8, the STA 100 acquires, from each of the plurality of APs 102 to 106, information indicating an AP-specific time period during which the corresponding AP is able to receive the UL data frames within the TXOP used for the UL burst by the STA 100. This AP-specific time period may be given in the UL burst limit-field. As a result, the STA 100 may in step 802 transmit UL data frames to the corresponding APs only during the indicated AP-specific time periods (i.e. during the AP-specific UL burst limits).

The UL burst limit-value of zero may have a special meaning. In an embodiment, the AP-specific time period of zero denotes that the corresponding AP is able to receive a single one UL data frame within the TXOP 416 used for the UL burst. I.e. the STA 100 may transmit a single PPDU to the corresponding AP 102, 104, or 106. In another embodiment, the value of zero (0) enables one UL data frame (e.g. PPDU) transmission which total size is less than 400 octets and the PPDU may be transmitted only to trigger service period with respect to the corresponding AP 102, 104, or 106.

In the embodiment where only a single bit is set to 1 to indicate that UL burst transmissions from the STA 100 are allowed, the STA may, as shown in step 804 of FIG. 8, receive, from each of the plurality APs 102 to 106, information indicating AP-specific TXOP durations allowed by the corresponding AP 102, 104, 106. The several AP-specific TXOP durations may be further AC-specific, that is, there may be one TXOP limit for each access category. It should be noted that each AP 102 to 106 may indicate the TXOPLimit values to the STA 100 as part of the EDCA parameters, for example. In this manner, the STA 100 may have knowledge of AP-specific TXOP limitations (i.e. the TXOPLimit values) for each of the APs 102 to 106. In step 806, the STA 100 may determine the longest AP-specific TXOP duration among the several AP-specific TXOP durations for each AP 102 to 106. Then in step 808, the STA 100 may consider the determined longest AP-specific TXOP duration for each of the plurality of access points as the time periods during which the corresponding APs 102, 104, 106 are able to receive UL data frames within the multipath TXOP. It should be noted that in this embodiment, the STA 100 may not be aware of the AP-specific UL burst limit-fields as no UL burst elements 700 are received by the STA 100. Instead, the TXOPLimit may be used as the UL burst limit value for the APs 102 to 106.

It should be noted, that EDCA rules define 4 access categories, i.e. priority levels for the traffic. The priority levels are defined for voice, streaming, best effort and background traffic. Typically only a single traffic type is transmitted within a single TXOP. When multipath TXOP is used, traffic from any access category may be transmitted. In other embodiment, each multipath TXOP transmits traffic only from a single access category.

As a result, in step 810 of FIG. 8, the STA 100 may determine the total duration of the multipath TXOP (e.g. the UL burst 416) comprising the UL data frame transmissions to the plurality of APs based on the indicated AP-specific time periods (i.e. based on the longest of the indicated UL burst field values) or based on the longest AP-specific TXOP durations (i.e. based on the longest TXOPLimit-values). In this manner the total duration of the multipath TXOP, such as the UL burst 416, depends on the APs 102 to 108 to which the transmissions are addressed to.

In one embodiment, a preconfigured parameter value stored in the UE 100 is considered as the time period during which the APs 102 to 106 are able to receive the UL data frames within the multipath TXOP, i.e. as the total duration of the multipath TXOP. Let us call this preconfigured parameter as a dot11MaxULBurstLength. The dot11MaxULBurstLength may be a preconfigured value in a terminal that sets the maximum duration in 32 microseconds for the multipath TXOP.

In another embodiment, the preconfigured parameter, i.e. the dot11MaxULBurstLength, is considered as the maximum number of APs to which UL data frames are transmitted within the multipath TXOP. I.e. the parameter dot11MaxULBurstLength sets the maximum number of APs that may receive traffic during the multipath TXOP.

In an embodiment, the dot11MaxULBurstLength-parameter may be a roaming identity (ID) specific or a homogenous extended service set ID (HESSID)-specific value and transmitted in the beacons of all APs that belong to the roaming ID or to the HESSID. In another embodiment, the dot11MaxULBurstLength is configured to the terminal 100 when the security keys of the roaming ID are set to the terminal 100.

FIG. 9 shows an example of UL data frame transmission to different APs 102, 104 and 106 on a time line 900 (an example of UL burst). First the STA 100 may acquire the TXOP. This may be acquired as defined by the EDCA parameters, for example. Then the STA 100 may transmit the trigger frame to the AP 102, for example, as shown with the block with left leaning diagonal lines, and receive an ACK from the AP 102. Thereafter, the STA 100 may transmit the trigger frame to the AP 104, for example, as shown with the block with horizontal lines, and receive an ACK from the AP 104 within the same multipath TXOP. Thereafter, the STA 100 may transmit the trigger frame to the AP 106, for example, as shown with the block with vertical lines, and further transmit another UL data frame to the same AP 106 within the same multipath TXOP. Then the STA 100 may receive an ACK from the AP 106. Thereafter, the STA 100 may transmit another UL data frame to the AP 102 as shown with the block with left leaning diagonal lines, and receive an ACK from the AP 102 within the same multipath TXOP. It may be that the AP 102 has defined that the UL burst limit corresponds to the time duration 902. The AP 104 may have defined that the UL burst limit of the AP 104 corresponds to the time duration 904 and allows only a single frame to be transmitted to the AP 104. The AP 106 may have defined that the UL burst limit of the AP 106 corresponds to the time duration 906 and allows the STA 100 to transmit multiple UL frames to the AP 106. Any of the data and ACK transmissions shall not exceed the AP-specific UL burst limits. In this example embodiment, the total length of the multipath TXOP, i.e. the duration of the UL burst, may be defined according to the longest UL burst limit, which corresponds to the time period 902.

In an embodiment, when a very high throughput (VHT) radio is used to transmit the UL transmissions of a single UL burst, the VHT-SIG-A field of the PLOP header of the transmitted UL frame may be set to a special value indicating that the current UL transmission belongs to a TXOP comprising UL transmissions to a plurality of APs 102 to 106. In one embodiment, the TXOP_PS_NOT_ALLOWED field of the VHT_SIG-A of the PLCP is set to 1. In prior art, this field is reserved for non-AP STA transmissions. When the field is set to 1, the APs 102 to 106 receive GROUP_ID and PARTIAL_AID of the frame in order to detect if they are or any of them is the receiver(s) of the transmission. In another embodiment, the GROUP_ID field of the VHT-SIG-A is set to 0, addressed to a specific AP 102, 104, or 106 and the PARTIAL_AID includes the bits [39:47] of the transmitter's MAC address. In this operation, the APs 102 to 106 receive only those PARTIAL_AIDs that match to the UL burst transmitter.

In an embodiment, the STA 100 may apply a More Data-field in the transmitted UL data frame in order to force the corresponding AP 102, 104, or 106 not to terminate the current service period. This may be important as the STA 100 may be left with some un-transmitted UL data in its buffer if the UL burst length (e.g. the maximum UL burst limit value of the addressed APs 102 to 106) is too short to transmit all the UL data. In this case, the UL burst enabled STA 100 may use the “More Data=1” bit to signal the transmission of the last frame to the corresponding AP 102, 104, or 106. If the corresponding AP 102, 104, or 106 receives a frame with the More Data-field set to 1, the AP is not allowed to terminate the current service period. Instead, the AP may respond by transmitting a frame with EOSP bit set to 0. That is, the More Data-bit may be used to mandate the corresponding AP 102, 104, 106 to follow the value of the More Data field.

In another embodiment, the STA 100 may transmit a “More Data=0”-indication, according to which the corresponding AP 102, 104, 106 may immediately send the service period termination frame (EOSP=1). This may be valid case when there is no more UL data left for transmitting.

It should be noted that although FIG. 4 illustrates only two APs 102 and 104 for reasons of simplicity, the number of APs of the wireless local area network may be larger than two. In such embodiment, the STA 100 may transmit at least one UL data frame to each of the more than two APs 102 to 106 within the same TXOP. In an embodiment, each of the more than two APs 102 to 106 apply the same primary channel.

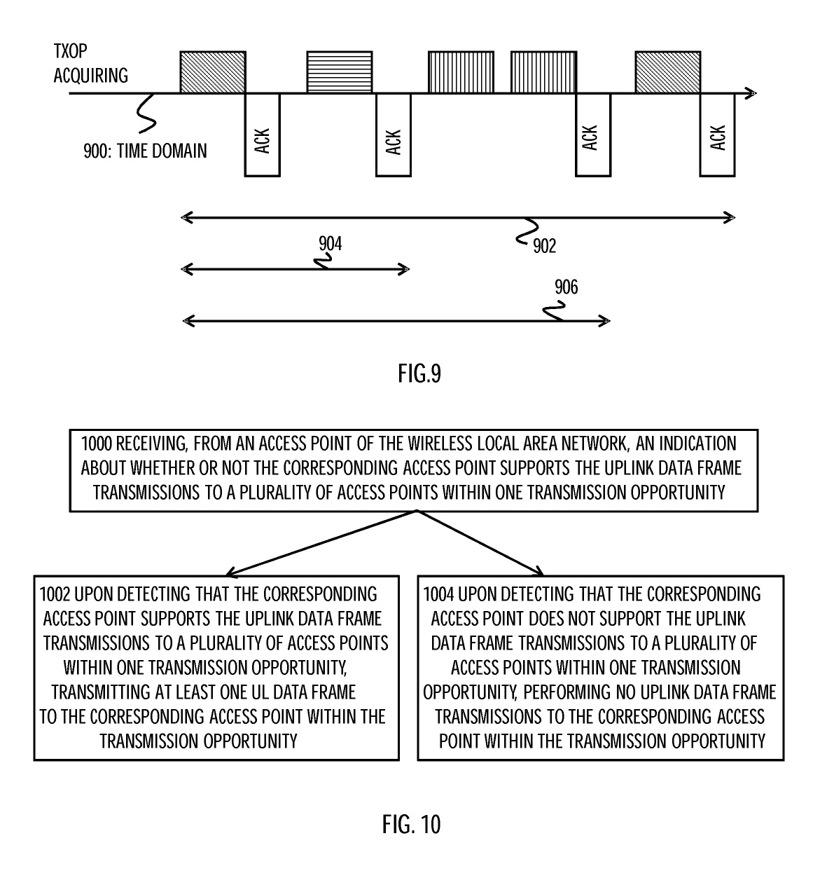

In an embodiment, as shown in FIG. 10, the STA 100 may receive in step 1000, from the AP 102, 104, or 106, an indication about whether or not the corresponding AP supports the UL data frame transmissions to a plurality of APs within one TXOP. The indication may be given in a similar fashion as the UL burst element 700, or it may be a single bit, as explained above. In step 1002, upon detecting that the corresponding AP supports the UL data frame transmissions to a plurality of APs within one TXOP, the STA 100 may transmit at least one UL data frame to the corresponding AP within the (multipath) TXOP. However, in case the STA 100 detects in step 1004 that corresponding AP does not support the transmission of UL data frames to a plurality of APs within one TXOP, the STA 100 may not perform any UL data frame transmissions (restrain from transmitting) to the corresponding AP within the (multipath) TXOP, such as within the TXOP/UL burst 416. This may be advantageous so that the STA 100 immediately acquired knowledge of whether or not any UL data frames may be sent to a certain AP during the TXOP comprising the transmission of UL data frames to a plurality of different APs 102 to 106.

When a specific AP does not support, the STA 100 may transmit UL traffic frequently to the specific AP in order to maintain the service period ongoing. This ensures that the specific AP does not consider that the STA 100 has transmitted all its UL traffic and that the specific AP does not try to terminate the service period by transmitting a frame with EOSP=1 to the STA 100. For example, after the WLAN STA 100 has transmitted a trigger frame to the specific AP, the WLAN STA 100 may try to transmit the UL traffic consecutively, so that a PPDU (i.e. an UL data frame) is transmitted to the specific AP at least once within the dot11ULBurstinterval. Default value for dot11ULBurstinterval may be 8 ms.

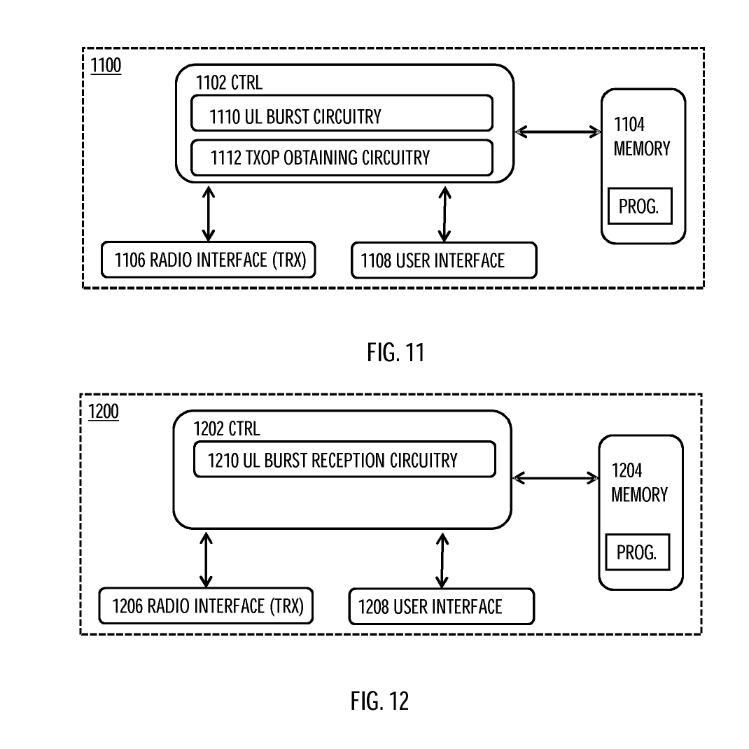

FIGS. 11 to 12 provide apparatuses 1100, and 1200 comprising a control circuitry (CTRL) 1102, 1202, such as at least one processor, and at least one memory 1104, 1204 including a computer program code (PROG), wherein the at least one memory and the computer program code (PROG), are configured, with the at least one processor, to cause the respective apparatus 1100, 1200 to carry out any one of the embodiments described. The memory 1104, 1204 may be implemented using any suitable data storage technology, such as semiconductor based memory devices, flash memory, magnetic memory devices and systems, optical memory devices and systems, fixed memory and removable memory.

The apparatuses 1100, 1200 may further comprise communication interfaces (TRX) 1106, 1206 comprising hardware and/or software for realizing communication connectivity according to one or more communication protocols. The TRXs may provide the apparatus with communication capabilities to access the wireless local area network, for example.

The apparatuses 1100, 1200 may also comprise user inter-faces 1108, 1208 comprising, for example, at least one keypad, a micro-phone, a touch display, a display, a speaker, etc. Each user interface may be used to control the respective apparatus by the user.

In an embodiment, the apparatus 1100 may comprise the terminal device of a wireless local area communication system, e.g. a user equipment (UE), a user terminal (UT), a computer (PC), a laptop, a tabloid computer, a mobile phone, a communicator, a smart phone, a palm computer, or any other communication apparatus. Alternatively, the apparatus 1100 is comprised in such a terminal device. Further, the apparatus 1100 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 1100 may be, comprise or be comprised in a WLAN station, such as the STA/UE 100, operating according to the IEEE 802.11 specification.

The control circuitry 1102 may comprise an UL burst circuitry 1110 for performing the functionalities related to transmission of UL data frames to a plurality of APs within one transmission opportunity, according to any of the embodiments. The circuitry may, e.g. determine the target APs for each (multipath) TXOP. The control circuitry 1102 may further comprise a TXOP obtaining circuitry 1112 for determine when to apply the UL burst, i.e. when to apply such TXOP comprising transmission to a plurality of APs. This circuitry 1112 may be responsible for detecting/determining the EDCA parameters and traffic load, for example.

In an embodiment, the apparatus 1200 may be or be comprised in a WLAN access point, such as a WLAN base station. In an embodiment, the apparatus 1200 is or is comprised in the access point 102, 104 or 106.

The control circuitry 1202 may comprise an UL burst reception circuitry 1210 for determining whether or not the corresponding apparatus supports the UL bursts from the STAB, and for receiving the UL data frames comprised in the UL burst, for example.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
transmitting, by a user equipment, at least one uplink data frame to a first access point of a wireless local area network, wherein the first uplink data frame of the transmitted at least one uplink data frame initiates a transmission opportunity; and
transmitting at least one uplink data frame to a second access point of a wireless local area network within the same transmission opportunity.

2. The method of claim 1, further comprising:
receiving an acknowledgement frame from a corresponding access point with respect to the transmitted at least one uplink data frame.

3. The method of claim 1, further comprising:
waiting a time period, which is shorter than a distributed inter-frame space between the data frame transmissions to different access points within the same transmission opportunity.

4. The method of claim 1, further comprising:
determining to perform uplink data frame transmissions to a plurality of access points within the same transmission opportunity; and
informing the corresponding access points that the current transmission opportunity comprises uplink data frame transmissions to the plurality of access points.

5. The method of claim 1, further comprising:
defining a condition that is required to be fulfilled before triggering the transmission opportunity for the uplink data frame transmissions to a plurality of access points; and
upon determining that the condition is met, initiating the transmission opportunity comprising the uplink data frame transmissions to the plurality of access points.

6. The method of claim 5, wherein the condition is defined by enhanced distributed access control parameters and the condition requires at least that a traffic load on an applied channel is below a predetermined threshold.

7. The method of claim 1, further comprising:
receiving, from the first and second access points, an indication according to which the corresponding access point supports the uplink data frame transmissions to a plurality of access points within one transmission opportunity.

8. The method of claim 1, further comprising:
receiving, from each of a plurality of access points, information indicating an access point-specific time period during which the corresponding access point is able to receive the uplink data frames within a transmission opportunity comprising uplink data frame transmissions to a plurality of access points; and
transmitting, within the transmission opportunity, uplink data frames to the corresponding access points only during the indicated access point-specific time periods.

9-15. (canceled)

16. A method, comprising:
transmitting, by an access point of a wireless local area network, a message to a user equipment, wherein the message indicates whether or not the access point supports uplink data frame transmissions by the user equipment to a plurality of access points within one transmission opportunity.

17. The method of claim 16, further comprising:
transmitting the message in at least one of the following: a beacon, a probe response message, an association response message, a dedicated message.

18. An apparatus, comprising:
at least one processor and at least one memory including a computer program code, wherein the at least one memory and the computer program code are configured, with the at least one processor, to cause the apparatus at least to:
cause a transmission of at least one uplink data frame to a first access point of a wireless local area network, wherein the first uplink data frame of the transmitted at least one uplink data frame initiates a transmission opportunity; and
cause a transmission of at least one uplink data frame to a second access point of a wireless local area network within the same transmission opportunity.

19. The apparatus of claim 18, wherein the at least one memory and the computer program code are configured, with the at least one processor, to cause the apparatus further to:
cause a reception of an acknowledgement frame from a corresponding access point with respect to the transmitted at least one uplink data frame.

20. The apparatus of claim 18, wherein the at least one memory and the computer program code are configured, with the at least one processor, to cause the apparatus further to:
wait a time period, which is shorter than a distributed inter-frame space between the data frame transmissions to different access points within the same transmission opportunity.

21. The apparatus of claim 18, wherein the at least one memory and the computer program code are configured, with the at least one processor, to cause the apparatus further to:
determine to perform uplink data frame transmissions to a plurality of access points within the same transmission opportunity; and
inform the corresponding access points that the current transmission opportunity comprises uplink data frame transmissions to the plurality of access points.

22. The apparatus of claim 18, wherein the at least one memory and the computer program code are configured, with the at least one processor, to cause the apparatus further to:
define a condition that is required to be fulfilled before triggering the transmission opportunity for the uplink data frame transmissions to a plurality of access points; and
upon determining that the condition is met, initiate the transmission opportunity comprising the uplink data frame transmissions to the plurality of access points.

23. The apparatus of claim 22, wherein the condition is defined by enhanced distributed access control parameters and the condition requires at least that a traffic load on an applied channel is below a predetermined threshold.

24. The apparatus of claim 18, wherein the at least one memory and the computer program code are configured, with the at least one processor, to cause the apparatus further to:
cause, from the first and second access points, a reception of an indication according to which the corresponding access point supports the uplink data frame transmissions to a plurality of access points within one transmission opportunity.

25. The apparatus of claim 18, wherein the at least one memory and the computer program code are configured, with the at least one processor, to cause the apparatus further to:
cause, from each of a plurality of access points, a reception of information indicating an access point-specific time period during which the corresponding access point is able to receive the uplink data frames within a transmission opportunity comprising uplink data frame transmissions to a plurality of access points; and
cause, within the transmission opportunity, a transmission of uplink data frames to the corresponding access points only during the indicated access point-specific time periods.

26-32. (canceled)

33. An apparatus, comprising:
at least one processor and at least one memory including a computer program code, wherein the at least one memory and the computer program code are configured, with the at least one processor, to cause the apparatus at least to:
cause an access point of a wireless local area network to transmit a message to a user equipment, wherein the message indicates whether or not the access point supports uplink data frame transmissions by the user equipment to a plurality of access points within one transmission opportunity.

34. The apparatus of claim 33, wherein the at least one memory and the computer program code are configured, with the at least one processor, to cause the apparatus further to:
cause a transmission of the message in at least one of the following: a beacon, a probe response message, an association response message, a dedicated message.

35-52. (canceled)
